(19) United States
(12) Patent Application Publication
(10) Pub. No.: US 2026/0367575 A1
(43) Pub. Date: Nov. 19, 2026

(54) WATCH COMPRISING A HOROLOGY MOVEMENT COMPRISING AN EARTH PHASE AND EARTHRISE DISPLAY DEVICE

(71) Applicant: ETA SA Manufacture Horlogère Suisse, Grenchen (CH)

(72) Inventor: Stéphane BACHMANN, Büren an der Aare (CH)

(73) Assignee: ETA SA Manufacture Horlogère Suisse, Grenchen (CH)

(21) Appl. No.: 19/652,336

(22) Filed: Apr. 20, 2026

(30) Foreign Application Priority Data
May 16, 2025 (EP) 25177071.5

(51) Int. Cl. G04B 19/26; G04B 19/02

(52) U.S. Cl. CPC G04B 19/26; G04B 19/02

(57) ABSTRACT

A watch (10) including a horology movement (30) including a finishing gear train and an Earth phase and Earthrise display device (100). The Earth phase and Earthrise display device (100) includes: a reduction gear train (120) connected to the finishing gear train of the horology movement (30); a display wheel (110) bearing a graphical representation of the Earth, (111), with the display wheel (110) engaging with the reduction gear train (120); a differential (200) including a first entry connecting the finishing gear train to an exit of the differential (200), and a second entry connecting a drive mechanism to the exit of the differential (200); and a mask (231) arranged opposite the display wheel (110) that is integral with the exit of the differential (200). The device (100) is configured such that the display wheel (110) and the mask (231) are caused to move relative to one another.

### CROSS-REFERENCE TO RELATED APPLICATIONS

This application claims priority to European Patent Application No. 25177071.5, filed on May 16, 2025, the entire contents of which are incorporated herein by reference.

### TECHNICAL FIELD OF THE INVENTION

The invention relates to the field of horology and in particular to devices for displaying a time value on a timepiece.

More specifically, the invention relates to a watch equipped with a horology movement comprising an Earth phase and Earthrise display device. The display device is capable of indicating which part of the Earth is visible from the Moon, and in particular of indicating the phases of the Earth and the Earthrises as they would be perceived by an observer from the Moon.

### TECHNOLOGICAL BACKGROUND

In the field of horology, particularly with regard to horological complications, it may be desirable to offer unexpected or commemorative displays so that the aesthetic appearance of the watch is particularly distinctive and attractive. Visual animation is one of the many solutions provided.

Moon phase displays are quite common in the field of horology, as are Earth phase displays, in other words, displays of the part of the Earth visible from the Moon.

Moon or Earth phase display devices considerably complicate the horology movement into which they are incorporated.

The invention meets the need for an attractive display of Earth phases.

### SUMMARY OF THE INVENTION

The present invention aims to enable the Earth phase and the part of the Earth's surface that can be seen by an observer orbiting the Moon to be indicated simultaneously in a single dial aperture.

To this end, the invention relates to a watch comprising a horology movement comprising a finishing gear train and an Earth phase and Earthrise display device. The Earth phase and Earthrise display device comprises:
a reduction gear train connected to the finishing gear train of the horology movement,
a display wheel bearing a graphical representation of the Earth, with said display wheel engaging with the reduction gear train,
a differential comprising a first entry connecting the finishing gear train to an exit of the differential, and a second entry connecting a drive mechanism to the exit of the differential,
a mask arranged opposite the display wheel that is integral with the exit of the differential.

The Earth phase and Earthrise display device is configured such that the display wheel and the mask are caused to move relative to one another.

In particular embodiments, the invention can further comprise one or more of the following features, taken separately or in any technically possible combination.

In particular embodiments, the exit of the differential is formed by a planetary carrier bearing planet gears that engage with one another, by means of which it is kinematically connected to the first entry and the second entry of the differential.

In particular embodiments, the second entry of the differential is formed by a sun gear comprising an axis of the differential, a driving stage connected to the drive mechanism and a driven stage.

In particular embodiments, the sun gear engages with a jumper.

In particular embodiments, the first entry of the differential is formed by a ring gear comprising toothing, with which a first planet gear engages, and a second planet gear arranged such as to engage with the driven stage of the sun gear.

In particular embodiments, the reduction gear train is kinematically connected to the planetary carrier by the ring gear such that it drives the rotation of the mask at a rotational speed identical to that of the display wheel and in the same direction. The drive mechanism is formed by a moon phase drive mechanism, so as to periodically rotate the mask one step in the opposite direction of the display wheel.

In particular embodiments, the moon phase drive mechanism is configured to cause rotation of the mask periodically by one step in the opposite direction of the display wheel so as to complete one half turn less than the display wheel in 29.53 days.

In particular embodiments, the reduction gear train is kinematically connected to the planetary carrier by the ring gear such that it causes the mask to rotate at a rotational speed different from that of the display wheel and in the same direction, such that the mask is rotated one half turn less than the display wheel in 29.53 days.

In particular embodiments, the second entry is formed by a sun gear kinematically connected to a correction wheel connected to a control element such that when the control element is actuated by a user, it causes the mask to rotate by one step.

In particular embodiments, the display wheel and the ring gear are continuously rotationally driven by two wheels of the same mobile element of the reduction gear train.

### BRIEF DESCRIPTION OF THE FIGURES

Other features and advantages of the invention will become apparent from the following detailed description, given by way of non-limiting example, with reference to the attached drawings in which:

FIG. 1 shows a schematic detail view of a watch dial aperture comprising a device for displaying Earth phases and Earthrises according to an exemplary embodiment of the invention,

FIG. 2 shows a perspective top view of a horology movement comprising a device for displaying Earth phases and Earthrises according to an exemplary embodiment of the invention,

FIG. 3 shows a schematic sectional view of a differential of an Earth phase and Earthrise display device according to FIG. 2,

FIG. 4 shows an exploded view of the differential of FIG. 3.

It should be noted that the figures are not necessarily drawn to scale for clarity reasons.

### DETAILED DESCRIPTION OF THE INVENTION

The invention relates to a watch 10 comprising a dial 20 and a horology movement 30 comprising a finishing gear train known as such by a person skilled in the art. The finishing gear train is connected to an energy source such as a barrel kinematically connected to a regulating element or such as one or more electric motors.

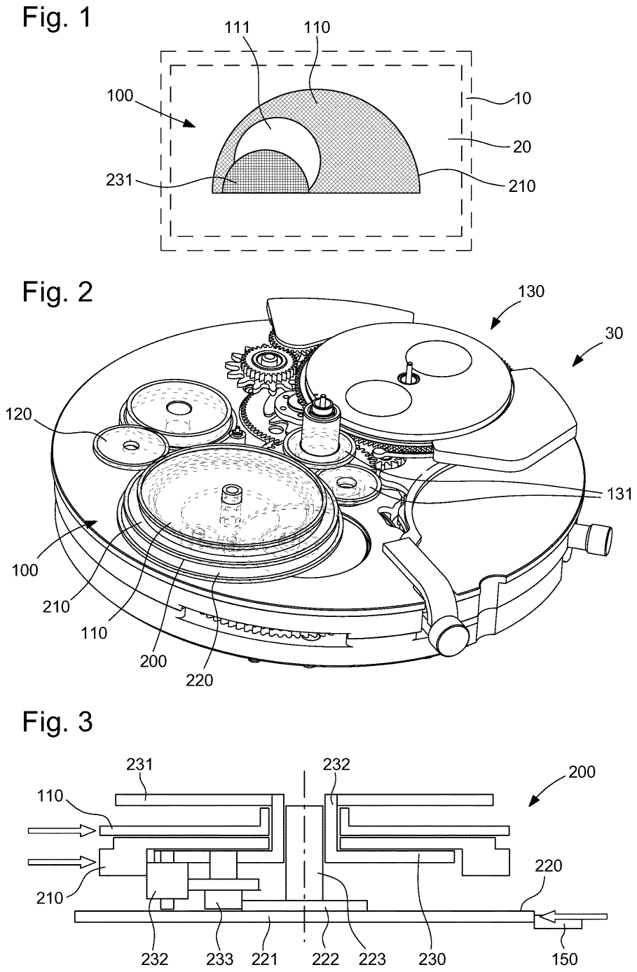

The watch 10 further advantageously comprises an Earth phase and Earthrise display device 100 comprising a display wheel 110 bearing at least one graphical representation of the Earth 111, as visible in FIG. 1.

The present invention makes it possible to display the evolution of the part of the Earth visible from the Moon, i.e., an Earthrise, and the Earth phase, i.e., the part of the Earth lit by the Sun.

Preferentially, the display wheel 110 is arranged opposite an aperture 210 made in the dial 20, such that the graphical representation of the Earth 111 is successively displayed through the aperture 210 upon rotation of the display wheel 110. In particular, in the exemplary embodiment of the invention depicted in FIG. 1, the aperture 210 has a substantially semi-circular shape, such that a portion of the display wheel 110 is hidden behind the dial 20 upon rotation.

The Earth phase and Earthrise display device 100 further comprises a differential 200 comprising a first entry connecting the finishing gear train to an exit of the differential 200, and a second entry connecting a drive mechanism to the exit of the differential 200.

The exit of the differential 200 integrally rotates with a mask 231 arranged opposite the display wheel 110 to alternately hide and reveal the graphical representation of the Earth 111.

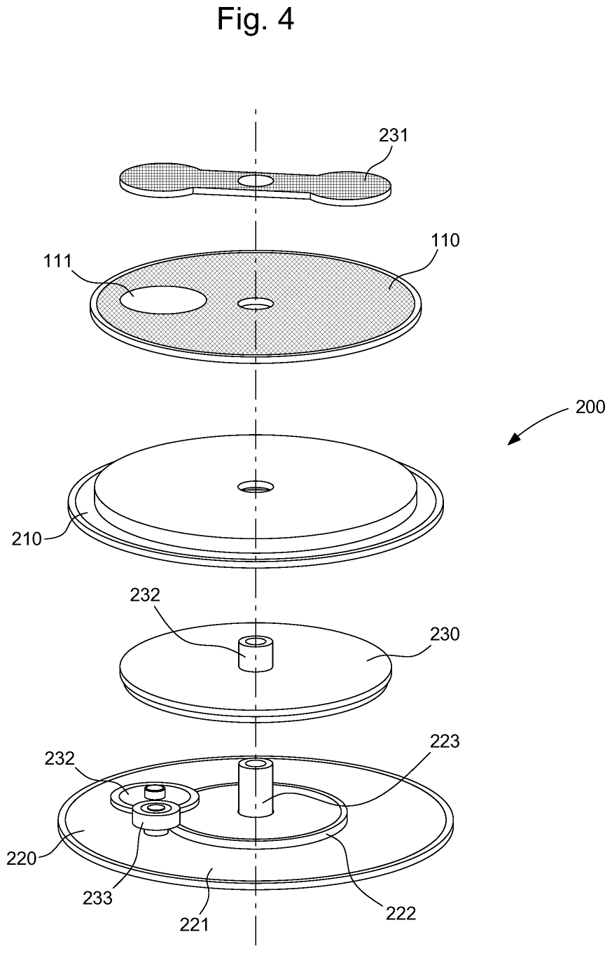

In particular, as visible in FIG. 4, the mask 231 is formed by two opaque areas connected to each other, wherein each is capable of hiding the graphical representation of the Earth 111. The mask 231 has, for example, an appearance identical to that of a background on which the graphical representation of the Earth 111 is made, for example a solid colour, as visible in FIGS. 1 and 4. In an example not shown in the figures, the mask 231 may include a transparent area for the display wheel 110 to appear, formed by a transparent material.

In particular, the Earth phase and Earthrise display device 100 is configured such that the display wheel 110 and the mask 231 are caused to move relative to one other as described below in different embodiments of the invention, such that the mask 231 gradually hides or reveals the graphical representation of the Earth 111 visible through the aperture.

Advantageously, the Earth phase and Earthrise display device 100 comprises a reduction gear train 120 kinematically connecting the finishing gear train, e.g., an intermediate wheel, with the display wheel 110 and with the first entry of the differential 200, as described in more detail in the remainder of the text. Thus, during normal operation of the watch, the display wheel 110 and the mask 231 are continuously rotated by a mobile element of the reduction gear train 120.

As described below, in a first embodiment, the display wheel 110 and the first entry are driven according to identical reduction ratios, and in a second embodiment, the display wheel 110 and the first entry are driven according to different reduction ratios.

The reduction gear 120 is sized to drive the display wheel 110 at a rotational speed of one turn every two hours.

In the embodiment shown in the figures and visible in particular in FIGS. 3 and 4, the exit of the differential 200 is formed by a planetary carrier 230 that is integral with the mask 231 via, for example, a pipe 232. The planetary carrier 230 is kinematically connected to the first entry and to the second entry of the differential 200 via the planet gears 232, 233 that it carries.

In the exemplary embodiments depicted in the figures, the first entry of the differential 200 is formed by a sun gear, and more precisely by a ring gear 210 having inner toothing. In addition, the second entry is formed by a sun gear 220 comprising a driving stage 221 and a driven stage 222, and bearing the axis 223 of the differential 200. As shown in FIGS. 3 and 4, the driving and driven stages 221 and 222 are centred on the axis 223 of the differential 200. Preferentially, either the driving stage 221 or driven stage 222 engages with a jumper not visible in the figures, directly or indirectly.

The differential 200 comprises a first planet gear 232 and a second planet gear 233 that engage with one another, wherein the first planet gear 232 is arranged to engage with the internal toothing of the ring gear 210 and the second planet gear 233 is arranged to engage with the driven stage 222 of the sun gear 220, as schematically shown in FIG. 3.

The ring gear 210 is driven rotationally in a direction opposite to that of the display wheel 110 since the differential 200 comprises two planet gears engaging with one another. It should be noted that the ring gear 210 would be driven in the same direction as the display wheel 110 if the differential included an odd number of planet gears, such as three planet gears.

In an exemplary embodiment of the invention, the Earth phase and Earthrise display device 100 is configured so that the ring gear 210 drives the rotation of the mask 231 at a rotational speed identical to that of the display wheel 110 and in the same direction. For this purpose, the reduction gear train 120, the ring gear 210 and the first and second planet gear 232 and 233 are appropriately sized. When rotating the ring gear 210, the planet gear 233 is forced to roll around the driven stage 222 of the sun gear 220.

In this embodiment, the Earth phase and Earthrise display device 100 is configured, further, such that the sun gear 220 causes the mask 231 to periodically rotate by one step in a direction opposite to that of the display wheel 110. The mask 231 is therefore driven with two combined rotational movements, one of which is continuous in a first direction and the other of which is discontinuous in a second direction opposite the first direction.

In particular, the sun gear 220 is connected, via the driving stage 221, to a moon phase drive mechanism 130, so as to drive the rotation of the mask 231. More specifically, the moon phase drive mechanism 130 is connected to the driving stage 221 by intermediate wheels 131. By rotating the driving stage 221, the intermediate wheels 131 cause the rotation of the second planet gear 233, which causes the first planet gear 232 to rotate against the toothing of the ring gear 210.

The moon phase drive mechanism 130 is configured to transmit a discontinuous rotational movement to the driving stage 221, once a day, such that the mask 231 makes one half turn less than the display wheel 110 in 29.53 days. Indeed, one cycle of Earth phases is completed in 29.53 days.

It should be noted that the moon phase drive mechanism 130 in the present invention may not be connected to a moon phase display. Indeed, a moon phase display is not essential for the present invention.

In summary, as can be seen in FIG. 1, when the mask 231 moves against the aperture 210, it can partially or completely cover the graphical representation of the Earth 111. As it rotates, the mask 231 therefore causes a variation in the visible surface of the graphical representation of the Earth 111, and more specifically by alternately increasing and reducing this visible surface. In other words, the graphical representation of the Earth 111 appearing through the aperture 210 is progressively successively revealed and concealed by the mask 231.

Thus, the present invention makes it possible to represent the vision of an observer rotating in orbit around the Moon and looking at the Earth. As a result, the watch 10 features a particularly attractive astronomical animation.

Advantageously, in the exemplary embodiment described above, the position of the mask 231 is dependent on the position of the moon phase 130. Thus, correcting the phase of the moon 130 causes the correction of the position of the mask 231.

In another exemplary embodiment of the invention, the display wheel 110 and the first entry of the differential 200 are continuously rotated by the reduction gear train 120 according to different reduction ratios.

In particular, as shown in FIG. 2, the display wheel 110 and the ring gear 210 of the differential 200 are rotationally driven by two different wheels of the reduction gear train 120 so as to turn in opposite directions. The reduction gear train is sized to drive the display wheel 110 at a rotational speed of one turn every two hours and to drive the ring gear 210 at a speed such that the mask 231 makes one half turn less than the display wheel 110 in 29.53 days.

The display wheel 110 and the ring gear 210 can be continuously rotationally driven by two wheels of the same mobile element of the reduction gear train.

In this exemplary embodiment of the invention, the drive mechanism connected to the exit of the differential 200 by the second entry of the differential 200 is a correction wheel 150. The second entry of the differential 200 is not connected to the moon phase device 130.

The correction wheel 150 is connected to a control element such that when the control element is actuated by a user, it drives the rotation of the planetary carrier 230, via the sun gear 220, clockwise or counterclockwise, by one step. Such a control element may be formed by a winding crown, a lever or a button and may be connected to the correction wheel 150 by a correction mechanism similar to that of a date corrector.

It should be noted that, for the sake of concision of the application, the components of the horology movement 30 known to a person skilled in the art are not described in this present text and do not appear in the figures.

Moreover, it should be noted that the embodiments and uses considered above have been described by way of non-limiting examples, and that other variants are therefore conceivable.

1. A watch (10) comprising a horology movement (30) comprising a finishing gear train and an Earth phase and Earthrise display device (100), wherein the Earth phase and Earthrise display device (100) comprises:
a reduction gear train (120) connected to the finishing gear train of the horology movement (30);
a display wheel (110) bearing a graphical representation of the Earth, (111), with said display wheel (110) engaging with the reduction gear train (120);
a differential (200) comprising a first entry connecting the finishing gear train to an exit of the differential (200), and a second entry connecting a drive mechanism to the exit of the differential (200); and
a mask (231) arranged opposite the display wheel (110) that is integral with the exit of the differential (200), wherein the Earth phase and Earthrise display device (100) is configured such that the display wheel (110) and the mask (231) are caused to move relative to one another.

2. The watch (10) according to claim 1, wherein the exit of the differential (200) is formed by a planetary carrier (230) bearing planet gears (232, 233) that engage with one another, by means of which it is kinematically connected to the first entry and the second entry of the differential (200).

3. The watch (10) according to claim 2, wherein the second entry of the differential (200) is formed by a sun gear (220) comprising an axis (223) of the differential (200), a driving stage (221) connected to the drive mechanism, and a driven stage (222).

4. The watch (10) according to claim 3, wherein the sun gear (220) cooperates with a jumper.

5. The watch (10) according to claim 3, wherein the first entry of the differential (200) is formed by a ring gear (210) comprising toothing, with which a first planet gear (232) engages and a second planet gear (233) is arranged so as to engage with the driven stage (222) of the sun gear (220).

6. The watch (10) according to claim 5, wherein the reduction gear train (120) is kinematically connected to the planetary carrier (230) by the ring gear (210) such that it drives rotation of the mask (231) at a rotational speed identical to that of the display wheel (110) and in the same direction, wherein the drive mechanism is formed by a moon phase drive mechanism (130), so as to cause the mask (231) to rotate periodically one step in the opposite direction of the display wheel (110).

7. The watch (10) according to claim 6, wherein the moon phase drive mechanism (130) is configured to cause rotation of the mask (231) periodically by one step in the opposite direction of the display wheel so as to complete one half turn less than the display wheel in 29.53 days.

8. The watch (10) according to claim 5, wherein the reduction gear train (120) is kinematically connected to the planetary carrier (230) by the ring gear (210) such that it causes the mask (231) to rotate at a rotational speed different from that of the display wheel (110) and in the same direction, such that the mask (231) is rotated one half turn less than the display wheel (110) in 29.53 days.

9. The watch (10) according to claim 8, wherein the second entry is formed by a sun gear (220) kinematically connected to a correction wheel (150) connected to a control element such that when the control element is actuated by a user, it causes the mask (231) to rotate by one step.

10. The watch (10) according to claim 5, wherein the display wheel (110) and the ring gear (210) are continuously rotationally driven by two wheels of the same mobile element of the reduction gear train (120).
